(19) United States
(12) Patent Application Publication
(10) Pub. No.: US 2019/0052111 A1
(43) Pub. Date: Feb. 14, 2019

(54) WIRELESS POWERED PORTABLE VIRTUAL REALITY HEADSET HOST SYSTEM

(71) Applicant: Intel Corporation, Santa Clara, CA (US)

(72) Inventors: Jr-Wei Wu, Taipei City (TW); Chetan Verma, Bangalore (IN); Aiswarya M. Pious, Bangalore (IN)

(73) Assignee: Intel Corporation, Santa Clara, CA (US)

(21) Appl. No.: 15/571,626

(22) PCT Filed: Nov. 16, 2016
(86) PCT No.: PCT/US16/62185

§ 371 Date: Nov. 3, 2017

(51) Int. Cl. H02J 7/02; H02J 50/20; H02J 50/40; H02J 50/10; G09G 3/20

(52) U.S. Cl. CPC H02J 7/025; H02J 50/20; G09G 2330/021; H02J 50/10; G09G 3/2096; H02J 50/40

(57) ABSTRACT

System and techniques for wireless charging of a portable virtual reality (VR) host system are described herein. The present subject matter provides various examples to power a portable VR host system that allows for free movement by the user. In various embodiments the present subject matter provides connections on the footwear of the user that supply electrical power to a VR host worn by the user. In various examples, a connection technology is employed to provide connections between the user wearing the VR host system and conductive mats, plates, or flooring that are powered to provide electrical power to the VR host system via connections to the user's apparel when standing. Other forms of connection technology may be employed, such as inductive wireless technology or radio frequency signal technology that uses wireless power coils or antennae to receive power and provide it to the VR host worn by the user.

### TECHNICAL FIELD

Embodiments described herein generally relate to methods and apparatus to provide a wireless, powered portable virtual reality headset.

### BACKGROUND

Virtual reality (VR) headsets provide an audiovisual experience for the wearer that requires substantial audio and visual processing to give the VR experience to the wearer. Such VR systems typically have the user in a stationary or sitting position. Immersive or more realistic VR experiences allow the user to get up and move. Systems providing these VR experiences allow the user to stand and even walk with a VR host. However, such immersive systems must be portable, require substantial processing power, and consume substantially more electrical power than stationary headset systems. There is a need in the art to provide a system to power a portable VR host without being cumbersome or impeding the movement of the user, so as to allow freedom of movement by the user and long periods of VR experience enjoyment for the user.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows a wired virtual reality host system that uses charging of VR host batteries via wired connections.

FIG. 2 shows a wireless portable virtual reality (VR) headset host system charging a battery of a VR host processor via wireless connections using the footwear of the user according to an embodiment of the present subject matter.

FIGS. 3A and 3B show an example of a wireless connection technology for a VR host system that provides connections in a variety of contact orientations according to an embodiment of the present subject matter.

FIG. 4 shows an example of a wireless connection technology for a VR host system that provides connections in both sitting and standing configurations according to an embodiment of the present subject matter.

FIG. 5 shows a wireless connection technology receiver for a VR host system according to an embodiment of the present subject matter.

FIG. 6 shows a front view of a wireless charging jacket for a VR host system according to an embodiment of the present subject matter.

FIG. 7 shows a back or rear view of a wireless charging jacket for a VR host system according to an embodiment of the present subject matter.

FIG. 8 shows a block diagram of a wireless battery charging system using wireless charging for a battery of a VR host system according to an embodiment of the present subject matter.

FIG. 9 shows a wireless battery charging system for a VR host system using wireless charging in a standing configuration according to an embodiment of the present subject matter.

FIG. 10 shows a block diagram of an example processor system for a VR host according to an embodiment of the present subject matter.

### DETAILED DESCRIPTION

Virtual Reality (VR) headsets provide an immersive experience to end-users. Compared to the standard stationary VR experience in which the user is sitting on a chair to watch images while wearing a VR headset, the immersive or “walking” VR experience with portable VR “host” becomes a new product line with different technical problems and interests. A VR host typically includes a high performance processor and hence consumes a lot of power. Thus, to make the VR host portable so it can operate for a sufficient time period a large capacity battery was necessary for the host system, which adds total system weight to the end-user. Also, the longer an end-user wants to experience VR, the larger they system battery must be. A hot-swap battery approach might be used to resolve the usable time issue, but will not address the weight problem, requires pausing of the game (which is not practical in online gaming) and also requires time to change out the battery. Some hot-swap approaches have a short battery life of about 2 to 3 hours, but these require frequent charging of VR headset batteries between gameplay sessions. Prolonged gaming requires longer battery life such as 8 to 10 hours. That cannot be achieved with conventional power supplies and still keep the form factor and weight of the VR host to a comfortable level. FIG. 1 shows a wired virtual reality host system that uses charging of VR host batteries via wired connections. Wired virtual reality host system 100 includes VR host processor 110 and batteries 120 in communication with VR headset 101. Wired virtual reality host system 100 operates on host batteries 120 which are charged via wired connections 130. Alternatively, batteries 120 can be charged by charger 140, which is plugged into the wall for charging using a wired connection 150. The batteries 120 may be swapped as needed to power host processor 110. Neither charging approach provides a long-term, uninterrupted, wireless portable solution for extended VR sessions.

To address the issues presented above, the present subject matter provides methods and apparatus in various embodiments to provide power to a portable virtual reality host system that allows for free movement by the user. In various embodiments, the present subject matter enables the user to receive power to a virtual reality host processing system to make the system portable. In various embodiments, the present subject matter provides power and signal connections to a virtual reality host processing system that allow for free movement by the user. In various embodiments the present subject matter provides connections on the footwear of the user that supply electrical power to a VR host worn by the user. In various embodiments of the present subject matter, a connection technology is employed to provide connections between the user wearing the VR host system and conductive mats, plates, or flooring that are powered to provide electrical power to the VR host system via connections to the user's footwear when standing. One example of a standard connection technology is the OPEN DOTS™ technology by the OPEN DOTS ALLIANCE, which is described at opendotsalliance.org and the Open Dots Technology Specification provided at http://opendotsalliance.org/wp-content/uploads/2014/10/OpenDotsSpecifications1dot2.pdf. Other forms of connection technology may be employed. For example, in various embodiments an inductive or radio frequency signal wireless technology is employed which uses traces in the form of one or more wireless power receiver coils (or antennae) to receive power that is provided to the VR host worn by the user. In various applications, the radio frequency signal technology includes Qi wireless charging, such as described at www.qiwireless.com. In various applications the radio frequency signal technology includes AirFuel wireless charging, such as described at www.airfuel.org. Other wireless charging technologies may be employed without departing from the present subject matter.

In various embodiments of the present subject matter, the connection technology is used to drive the PC refresh of the virtual reality processor. In such embodiments, smaller batteries may be employed for the VR host because is it getting charged as the user moves about the conductive area of the floor. One aspect of such systems is that they weigh less, because they are consistently charging a battery of the VR host, even under movement by the user. One aspect of such systems is that they are mobile and portable because there is no set of fixed wires to restrain the VR host. In certain embodiments, minimal battery capacity is required on the VR host as power buffer and power will be gathered from the ground with an embedded transmitter device (TX) to a receiver (RX) residing in or under the soles of the user's footwear. This enables the battery on the host processor to charge as long as at least one foot of the user is standing on the ground. Such approaches allow the weight of VR host to be minimized and yet the time the user can experience VR is virtually unlimited.

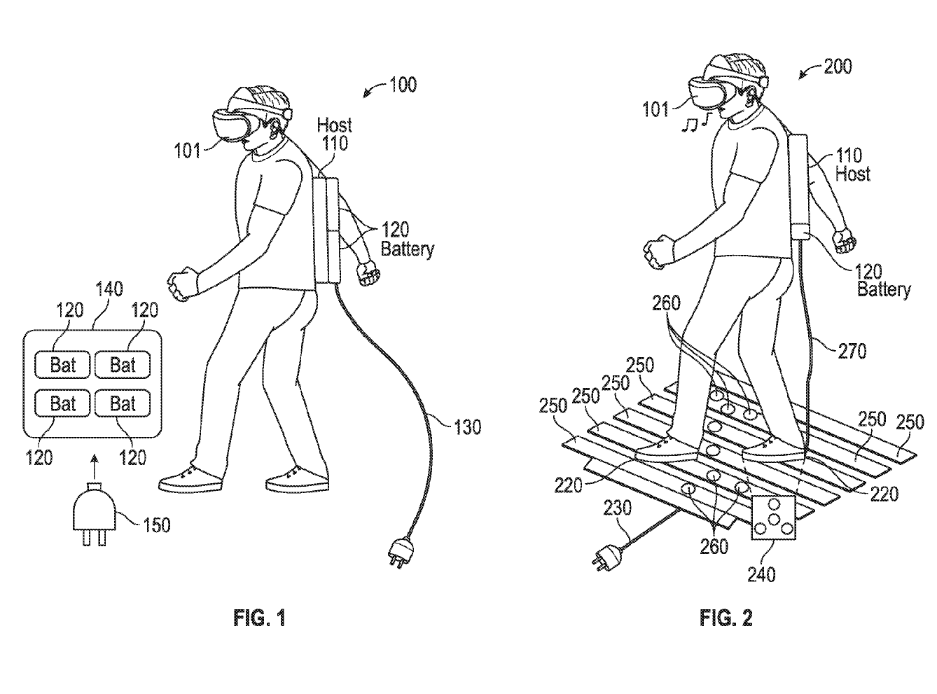

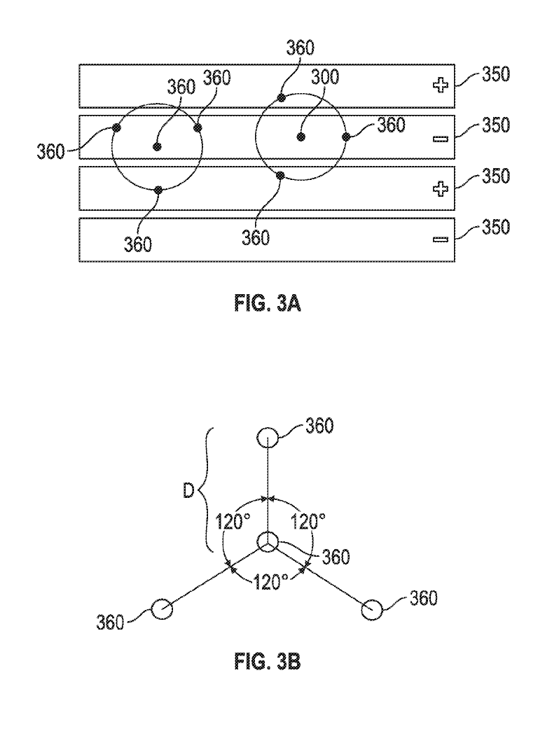

FIG. 2 shows a wireless portable virtual reality (VR) headset host system 200 charging the battery of a VR host processor 110 via wireless connections using the footwear 220 of the user according to an embodiment of the present subject matter. In various embodiments conductors 250 are used to provide connection for a variety of orientations of the transmitter and receivers employed by the system. FIG. 2 shows conductive portions 240 on the footwear 220 (receivers) of the wearer that make contact with conductive portions 260 of the conductors 250 (transmitters) of the flooring or a mat on the floor. Connection 270 provides connection of the battery 120 to conductive portions 240 on footwear 220. It is understood that this connection may be made in various ways, including but not limited to wiring in or on clothing. In various embodiments, a standard connection technology, such as the OPEN DOTS technology is used as the receiver and transmitter technology. In such embodiments, the OPEN DOTS technology provides a distribution of conductors on the powered side (e.g., flooring connected to a power supply) and on the receiving side (e.g., soles of footwear connected to the VR host) of the system. The distribution of conductors allows for power transfer in a plurality of different orientations. FIGS. 3A and 3B show an example of a wireless connection technology for a VR host system that provides connections in a variety of contact orientations according to an embodiment of the present subject matter. In an embodiment the various strips and dots use the OPEN DOTS technology to ensure power transfer for a variety of relative orientations of the powered strips to the dot powered receivers. In some embodiments a plurality of strips 350 each having strip width of 10.3 mm and inter-strip spacing of 1.9 mm is used with a dot-to-dot 360 spacing D of about 9.78 mm. This provides an X by Y pattern of 16.9×15.0 mm. Other spacings and configurations may be used as described in the Open Dots Technology Specification. OPEN DOTS is an open standard that ensures the receiver (RX) metal ball connections will have contact with the transmitter (TX) metal strip lines to retrieve power. The TX portion includes a short-proof circuit to prevent end-user from being electrical shocked. The RX portion employs rectifiers to convert the AC voltage gathered to DC voltage. The resulting DC power is fed via wires on the user to charge the VR host system.

In an example, a power cable from the VR host is connected to the receiver contacts on the footwear of the user. The material and design of such cabling can be varied to meet the needs of the wearer. The system provides the user a lighter weight VR host system, and increases the spatial freedom of the user to enjoy an immersive, moving VR experience with a practically unlimited power supply. This avoids the need to swap out power sources, to recharge them separately, and to replace multiple recharging batteries. The overall form factor and weight of the VR host system can be reduced and even minimized.

In an example, the connection technology is employed between the floor and footwear of the user. In various embodiments, the connection technology can be employed in other surfaces, including, but not limited to chairs, stools, seats, and beds. The connection technology can be used with props, such as a car prop, that may be used in a virtual reality application. the connection technology can be used with any object in the environment (room, VR arena, club, or other place) that is in proximity or close contact with the apparel of the wearer and can be used to deliver power to the battery of the VR host system of the wearer. The connection technology can be used with other articles of clothing besides footwear, such as pants, suits, jackets, coats, gloves, backpacks, and the like. Therefore, a connection technology can be employed whether the person is sitting, standing, laying down, or engaged in some other form of activity (e.g., riding a bicycle). Various combinations of connection technology can be employed to enhance the wearer's immersive experience.

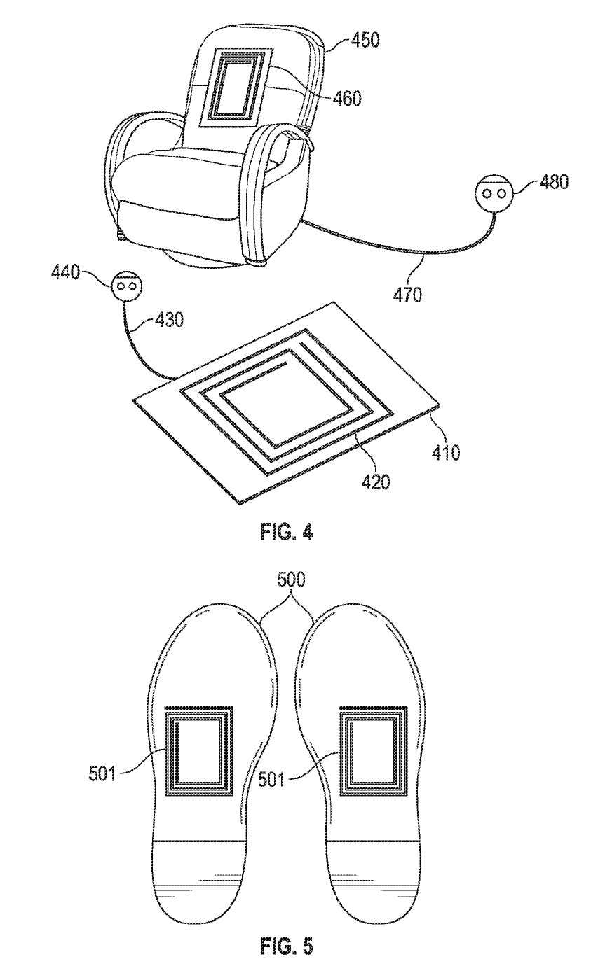

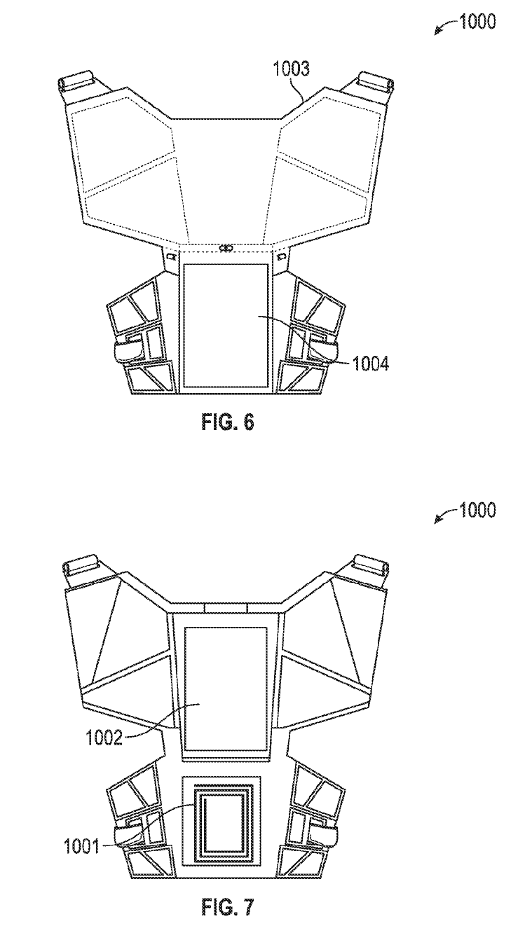

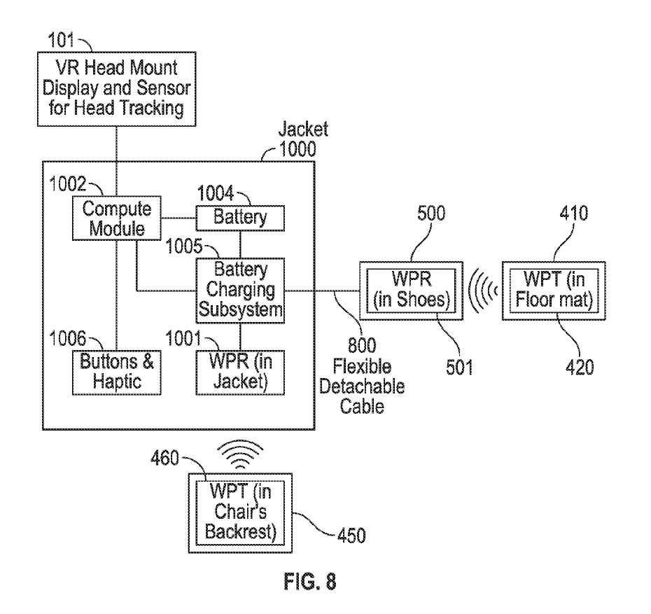

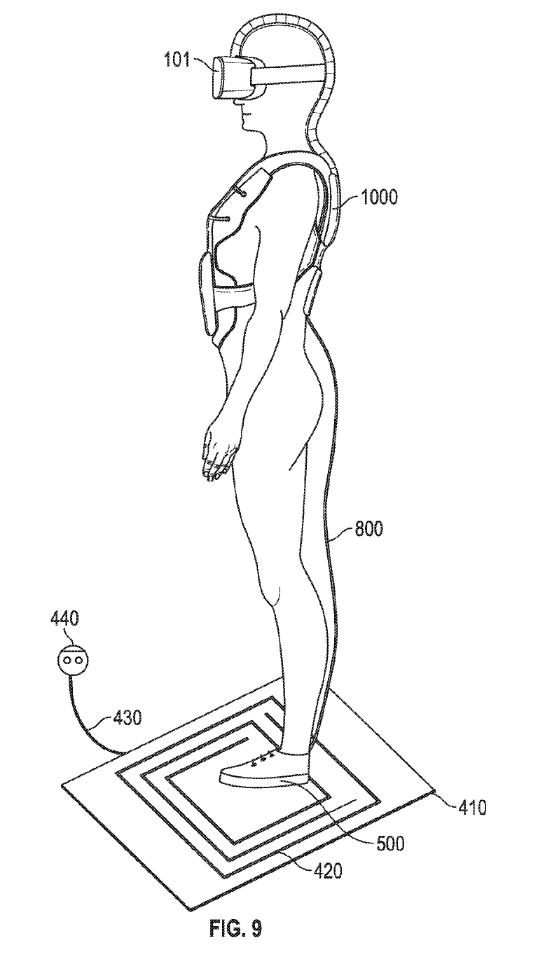

In various embodiments, a wireless inductive or radio frequency signal charging system can be used. FIG. 4 shows an example of a wireless connection technology for a VR host system that provides connections in both sitting and standing configurations according to an embodiment of the present subject matter. In FIG. 4, floor mat 410 and chair 450 with integrated wireless power transmitters 420, 460 are shown. In some embodiments, the wireless power transmitters 420, 460 are connected to AC wall power supply 440 and 480, respectively. Other power sources may be used, for example, the wall power supply may be stepped down or converted to other frequencies as desired for different applications. Cables 430 and 470 can be used to make connections. FIG. 5 shows a wireless connection technology receiver for a VR host system according to an embodiment of the present subject matter. FIG. 5 shows the soles of shoes 500, which include an integrated wireless power receiver 501. It is understood that socks and other footwear can be fitted with receivers 501. Therefore, a variety of apparel can be fitted with wireless receivers 501. A metal trace or lead can be disposed in or on the apparel to be worn by the user. These traces or leads may be in the form of coils that allow the wireless power receivers 501 to effectively electromagnetically couple with the wireless power transmitters 420, 460. In transmissions that are predominantly inductive or “near field” in nature, the transmissions are substantially magnetic in nature. Transmissions that are associated with radio frequencies and that have a “far field” component may be predominantly electric in nature and may also be used. Thus, different frequencies and electromagnetic power transfer mechanisms can be employed. In inductive or “near field” applications, when the soles 500 come in close contact with floor mat 410, wireless power transfer occurs through magnetic induction. The shoe's wireless power receiver (WPR, such as 501 in FIGS. 7 and 8) is connected to a jacket battery (such as battery 1004 in FIGS. 6 and 8) with flexible detachable cable 800 (such as in FIGS. 8 and 9), so that transmitted wireless power can be used to charge jacket battery 1004 Radio frequency signal technologies may also be used to transfer wireless power for charging.

FIG. 6 shows a front view of a wireless charging jacket 1000 for a VR host system according to an embodiment of the present subject matter. In FIG. 6, an example of wearable jacket's 1000 front view 1003 is shown, according to an embodiment. Also shown is battery 1004. FIG. 7 shows the back or rear side of jacket 1000, including the wireless charging receiver 1001 according to an embodiment. When the jacket's rear side is in close contact with chair's backrest 450, wireless power transfer occurs. The jacket's wireless charging receiver 1001 is connected to a jacket battery 1004 to charge it. The jacket 1000 also incorporates high performance compute module 1002, which is connected to a head mounted VR screen. Compute module 1002 includes the hardware to provide the VR host processing. Having the VR host processor inside the jacket 1000 powered by the battery 1004 of the jacket 1000 allows it to be untethered.

FIG. 8 shows a block diagram of a wireless battery charging system using wireless charging for a battery of a VR host system according to an embodiment of the present subject matter. The figure shows a block diagram of some different subsystems and how they can be connected according to an embodiment of the present subject matter. The VR head mounted display 101 is in communication with the compute module 1002 disposed in the jacket 1000 in this example embodiment. A battery 1004 is connected to provide power to the compute module 1002 and to receive power from the battery charging subsystem 1005. The wireless receiver 1001 in the jacket 1000 provides power when the wireless receiver 1001 is in proximity of a transmitter, such as the wireless transmitter 460 in the backrest of chair 450. The system allows for controls and interface to the compute module 1002, such as buttons and haptic feedback devices 1006. A flexible detachable cable 800 may be used to connect the jacket 1000 to other wireless receivers, such as receivers 501 in the user's shoes or other footwear 500. These receivers can receive power from transmitters 420 in the floor mat 410. It is understood that a variety of apparel and furniture/environment may be configured to provide wireless communications to the VR host using the teachings provided herein, and that the examples provided herein are intended to demonstrate the system. Other configurations, apparel, and connections may be used based on the teachings provided by this detailed description.

There are multiple positions (postures) for a user playing VR games, including standing and sitting. FIG. 9 shows a wireless battery charging system for a VR host system using wireless charging in a standing configuration according to an embodiment of the present subject matter. When the user is standing on floor mat 410 and playing VR games, such as shown in FIG. 9, wireless power may be transmitted by floor mat 410, because the user is wearing shoes with soles 500 having wireless power receiver 501. The shoes are able to receive wireless transmitted power (from floor mat) and transfer the power to the jacket using cable 800 running from shoe to jacket to charge battery 1004 in the jacket 1000.

In the case when the user is sitting on chair 450 and playing VR games, such as in FIG. 4, wireless power is transmitted by chair's backrest. Because the user is wearing the jacket 1000, which backside has a wireless power receiver (WPR 1001), the jacket's WPR 1001 receives wireless transmitted power (from the chair's backrest) to charge battery (1004) inside the jacket 1000. Also there is possibility when user is sitting on chair 450, the user is keeping the user's feet on the floor. In that case if user is wearing shoes 500 and jacket 1000 with WPR 1001 battery 1004 may also be charged from both chair 450 and floor mat 410.

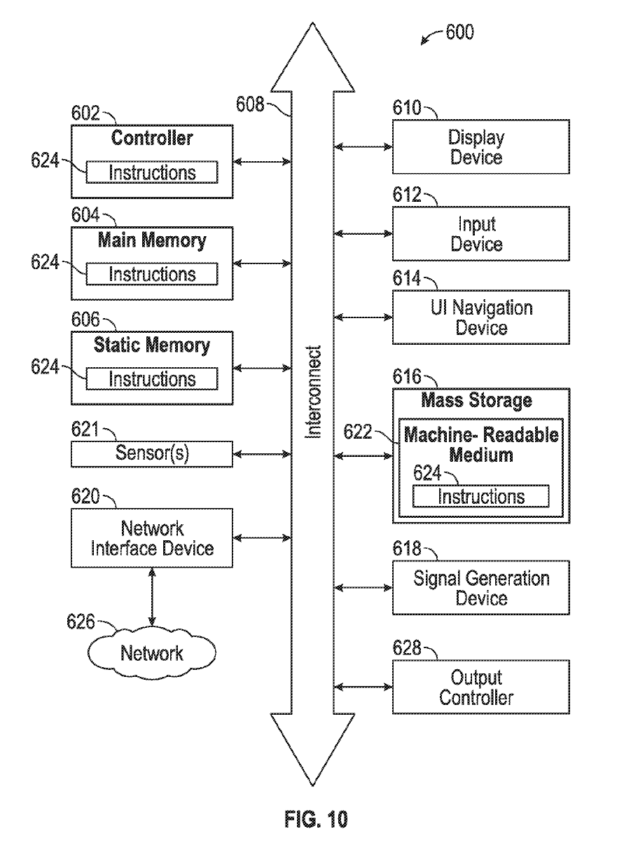

FIG. 10 shows a block diagram of an example processor system 600 for a VR host according to an embodiment of the present subject matter. In alternative embodiments, the processor system 600 may operate as a standalone system or may be connected (e.g., networked) to other machines. In a networked deployment, the processor system 600 may operate in the capacity of a server machine, a client machine, or both in server-client network environments. In an example, the processor system 600 may act as a peer machine in peer-to-peer (P2P) (or other distributed) network environment. Processor system 600 may include a personal computer (PC), a tablet PC, a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuitry is a collection of circuits implemented in tangible entities that include hardware (e.g, simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer readable medium physically modified (e g, magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e g, the execution units or a loading mechanism) to create members of the circuitry in hardware via the variable connections to carry out portions of the specific operation when in operation. Accordingly, the computer readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

Processor system 600 (e.g., computer system) may include a hardware processor 602 (e.g., a central processing unit (CPU), a graphics processing unit (GPU), a hardware processor core, or any combination thereof), a main memory 604 and a static memory 606, some or all of which may communicate with each other via an interconnect (e.g, bus) 608. The processor system 600 may further include a display unit 610, an alphanumeric input device 612 (e.g., a keyboard), and a user interface (UI) navigation device 614 (e.g., a mouse). In an example, the display unit 610, input device 612 and UI navigation device 614 may be a touch screen display. The machine processor system 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. Processor system 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, VR headset 101 etc.).

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the processor system 600 In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, and/or associated caches and servers) configured to store the one or more instructions 624.

The term “machine readable medium” may include any medium that is capable of storing, encoding, or carrying instructions for execution by the processor system 600 and that cause the machine processor system 600 to perform any one or more of the techniques of the present disclosure, or that is capable of storing, encoding or carrying data structures used by or associated with such instructions. Non-limiting machine-readable medium examples may include solid-state memories, and optical and magnetic media. In an example, a massed machine-readable medium comprises a machine-readable medium with a plurality of particles having invariant (e.g., rest) mass. Accordingly, massed machine-readable media are not transitory propagating signals. Specific examples of massed machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g, frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g, the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the processor system 600, and includes digital or analog communications signals or other intangible medium to facilitate communication of such software.

### Additional Notes & Examples

Example 1 is a virtual reality (VR) system for a user configured to be wirelessly charged by a wireless power transmitter, comprising, a VR headset; a VR host to communicate with the VR headset, the VR host having a battery; and a wireless connection system to receive power from the wireless power transmitter and to charge the battery of the VR host, the wireless connection system providing portability of the VR host and freedom of movement to the user.

In Example 2, the subject matter of Example 1 optionally includes wherein the wireless connection system comprises a distribution of conductors on a surface that the user is proximal to or in contact with, the distribution of conductors connected to the wireless power transmitter.

In Example 3, the subject matter of Example 2 optionally includes wherein the conductors are disposed at least in part on a floor.

In Example 4, the subject matter of Example 3 optionally includes wherein the conductors are disposed at least in part on a mat on the floor.

In Example 5, the subject matter of any one or more of Examples 2-4 optionally include wherein the conductors are disposed at least in part on a piece of furniture.

In Example 6, the subject matter of Example 5 optionally includes wherein the furniture is a prop.

In Example 7, the subject matter of any one or more of Examples 2-6 optionally include contacts disposed on apparel worn by the user, the contacts configured to electrically connect with at least some of the conductors as the user moves about.

In Example 8, the subject matter of Example 7 optionally includes wherein the contacts are metal dots configured to provide at least two points of contact with the conductors so as to receive electric current from the conductors for a variety of different orientations of the contacts with respect to the conductors

In Example 9, the subject matter of Example 8 optionally includes a detachable cable to connect the contacts with the VR host.

In Example 10, the subject matter of any one or more of Examples 8-9 optionally include a rectifier to convert alternating current to direct current.

In Example 11, the subject matter of any one or more of Examples 8-10 optionally include wherein the contacts and conductors are configured according to the OPEN DOTS technology.

In Example 12, the subject matter of any one or more of Examples 8-11 optionally include a detachable cable to connect the contacts with the VR host.

In Example 13, the subject matter of any one or more of Examples 2-12 optionally include a plurality of wireless power receiver coils or antennae disposed on apparel worn by the user, the wireless power receiver coils or antennae configured to receive power inductively or by radio frequency signals from at least some of the conductors connected to the wireless power transmitter as the user moves about and to provide that to the VR host, and wherein the conductors connected to the wireless power transmitter are coils.

In Example 14, the subject matter of any one or more of Examples 11-13 optionally include wherein the plurality of wireless power receiver coils or antennae are connected to rectifiers to convert alternating current to direct current.

In Example 15, the subject matter of any one or more of Examples 11-14 optionally include wherein the plurality of wireless power receiver coils or antennae are connected to the VR host by a detachable cable.

Example 16 is a method for wirelessly charging a battery of a virtual reality (VR) host of a user wearing a VR head mounted apparatus in communication with the VR host, the wireless charging of the battery of the VR host performed using an external wireless power transmitter, comprising: connecting the VR host to a plurality of wireless receivers of power disposed in or on apparel of the user; providing a plurality of conductors or coils in an environment of the user, the conductors or coils connected to the external wireless power transmitter and arranged in a pattern to transmit electric power to the plurality of wireless receivers depending on the motion and location of the user; and charging a battery of the VR host using the power received by the wireless receivers.

In Example 17, the subject matter of Example 16 optionally includes wherein the providing a plurality of conductors or coils comprises arranging the conductors or coils in a distribution on a surface that the user is proximal to or in contact with, the distribution of conductors or coils connected to the external wireless power transmitter.

In Example 18, the subject matter of Example 17 optionally includes disposing the conductors or coils at least in part on the floor.

In Example 19, the subject matter of Example 18 optionally includes disposing the conductors at least in part on a mat on the floor.

In Example 20, the subject matter of any one or more of Examples 17-19 optionally include disposing the conductors at least in part on a piece of furniture or object in a room that is proximal or in contact with the user.

In Example 21, the subject matter of Example 20 optionally includes wherein the furniture is a prop.

In Example 22, the subject matter of any one or more of Examples 17-21 optionally include wherein the receivers are contacts disposed on the apparel worn by the user, the contacts configured to electrically connect with at least some of the conductors as the user moves about.

In Example 23, the subject matter of Example 22 optionally includes wherein the contacts are metal dots configured to provide at least two points of contact with the conductors so as to receive electric current from the conductors for a variety of different orientations of the contacts with respect to the conductors.

In Example 24, the subject matter of Example 23 optionally includes wherein the contacts and conductors are configured according to the OPEN DOTS technology.

In Example 25, the subject matter of any one or more of Examples 17-24 optionally include disposing a plurality of wireless power receiver coils or antennae on the apparel worn by the user, the coils or antennae configured to receive power inductively or by radio frequency signals from at least some of the conductors as the user moves about and to provide that power to the VR host.

In Example 26, the subject matter of any one or more of Examples 17-25 optionally include wherein the apparel includes one or two shoes.

In Example 27, the subject matter of any one or more of Examples 17-26 optionally include wherein the apparel includes one or two socks.

In Example 28, the subject matter of any one or more of Examples 17-27 optionally include wherein the apparel includes a jacket or a backpack.

In Example 29, the subject matter of any one or more of Examples 17-28 optionally include wherein the apparel includes one or two gloves.

In Example 30, the subject matter of any one or more of Examples 17-29 optionally include wherein the apparel includes pants or skirts.

Example 31 is at least one machine-readable medium including instructions, which when executed by a machine, cause the machine to perform operations of any of the methods of Examples 16-30.

Example 32 is an apparatus comprising means for performing any of the methods of Examples 16-30.

Example 33 is an apparatus for wirelessly charging a battery of a virtual reality (VR) host of a user wearing a VR head mounted apparatus in communication with the VR host, the wireless charging of the battery of the VR host received from an external wireless power transmitter, comprising: means for connecting the VR host to a plurality of wireless receivers of power disposed in or on apparel of the user, means for providing a plurality of conductors in an environment of the user, the conductors connected to the external wireless power transmitter and arranged in a pattern to transmit electric power to the plurality of wireless receivers depending on the motion and location of the user; and means for charging a battery of the VR host using the power received by the wireless receivers.

In Example 34, the subject matter of Example 33 optionally includes wherein the means for providing a plurality of conductors comprises means for arranging the conductors in a distribution on a surface that the user is proximal to or in contact with, the distribution of conductors or coils connected to the external wireless power transmitter.

In Example 35, the subject matter of any one or more of Examples 33-34 optionally include wherein the means for providing a plurality of conductors are disposed at least in part on the floor.

In Example 36, the subject matter of any one or more of Examples 34-35 optionally include wherein the means for providing a plurality of conductors are disposed at least in part on a mat on the floor.

In Example 37, the subject matter of any one or more of Examples 34-36 optionally include wherein the conductors are disposed at least in part on a piece of furniture.

In Example 38, the subject matter of Example 37 optionally includes wherein the furniture is a prop.

In Example 39, the subject matter of any one or more of Examples 34-38 optionally include contact means disposed on apparel worn by the user, the contact means configured to electrically connect with at least some of the conductor means as the user moves about.

In Example 40, the subject matter of Example 39 optionally includes wherein the contact means are metal dots configured to provide at least two points of contact with the conductor means so as to receive electric current from the conductor means for a variety of different orientations of the contact means with respect to the conductor means.

In Example 41, the subject matter of Example 40 optionally includes a detachable cable to connect the contact means to the VR host.

In Example 42, the subject matter of any one or more of Examples 40-41 optionally include a rectifier to convert alternating current to direct current.

In Example 43, the subject matter of any one or more of Examples 40-42 optionally include wherein the contact means and conductor means are configured according to the OPEN DOTS technology.

In Example 44, the subject matter of any one or more of Examples 40-43 optionally include a detachable cable to connect the contact means with the VR host.

In Example 45, the subject matter of any one or more of Examples 35-44 optionally include a plurality of wireless power receiver coils or antennae disposed on apparel worn by the user, the wireless power receiver coils or antennae configured to receive power inductively or by radio frequency signals from at least some of the conductor means as the user moves about and to provide that to the VR host.

In Example 46, the subject matter of any one or more of Examples 43-45 optionally include wherein the plurality of wireless power receiver coils or antennae are connected to rectifiers to convert alternating current to direct current.

In Example 47, the subject matter of any one or more of Examples 43-46 optionally include wherein the plurality of wireless power receiver coils or antennae are connected to the VR host by a detachable cable.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document, for irreconcilable inconsistencies, the usage in this document controls.

The above description is intended to be illustrative, and not restrictive. For example, the above-described examples (or one or more aspects thereof) may be used in combination with each other. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description. The scope of the embodiments should be determined with reference to the appended claims, along with the full scope of equivalents to which such claims are entitled.

1-26. (canceled)

27. A virtual reality (VR) system for a user configured to be wirelessly charged by a power source, comprising:
a VR headset;
a VR host to communicate with the VR headset, the VR host having a power supply; and
a wireless connection system to receive power from the power source and to charge the power supply of the VR host, the wireless connection system providing portability of the VR host and freedom of movement to the user.

28. The system of claim 27, wherein the wireless connection system comprises a distribution of conductors on a surface that the user is proximal to or in contact with, the distribution of conductors connected to the power source.

29. The system of claim 28, wherein the conductors are disposed at least in part on a floor.

30. The system of claim 28, wherein the conductors are disposed at least in part on a piece of furniture.

31. The system of claim 28, further comprising contacts disposed on apparel worn by the user, the contacts configured to electrically connect with at least some of the conductors as the user moves about.

32. The system of claim 31, wherein the contacts are metal dots configured to provide at least two points of contact with the conductors so as to receive electric current from the conductors for a variety of different orientations of the contacts with respect to the conductors.

33. The system of claim 32, further comprising a detachable cable to connect the contacts with the VR host.

34. The system of claim 32, further comprising a rectifier to convert alternating current to direct current.

35. The system of claim 32, wherein the contacts and conductors are configured according to the OPEN DOTS technology.

36. The system of claim 28 further comprising a plurality of wireless receiver antennae disposed on apparel worn by the user, the antennae configured to receive power inductively from at least some of the conductors as the user moves about and to provide that to the VR host.

37. The system of claim 35, wherein the plurality of wireless receiver antennae are connected to rectifiers to convert alternating current to direct current.

38. The system of claim 35, wherein the plurality of wireless receiver antennae are connected to the VR host by a detachable cable.

39. A method for wirelessly powering a virtual reality (VR) host of a user wearing a VR head mounted apparatus in communication with the VR host, the wireless powering of the VR host received from an external power source, comprising:
connecting the VR host to a plurality of wireless receivers of power disposed in or on apparel of the user;
providing a plurality of conductors in an environment of the user, the conductors connected to the external power source and arranged in a pattern to transmit electric power to the plurality of wireless receivers depending on the motion and location of the user; and
charging a battery of the VR host using the power received by the wireless receivers.

40. The method of claim 39, wherein the providing a plurality of conductors comprises arranging the conductors in a distribution on a surface that the user is proximal to or in contact with, the distribution of conductors connected to the external power source.

41. The method of claim 40, comprising disposing the conductors at least in part on the floor.

42. The method of claim 40, comprising disposing the conductors at least in part on a piece of furniture.

43. The method of claim 40, wherein the receivers are contacts disposed on the apparel worn by the user, the contacts configured to electrically connect with at least some of the conductors as the user moves about.

44. The method of claim 43, wherein the contacts are metal dots configured to provide at least two points of contact with the conductors so as to receive electric current from the conductors for a variety of different orientations of the contacts with respect to the conductors.

45. The method of claim 44, wherein the contacts and conductors are configured according to the OPEN DOTS technology.

46. The method of claim 40, comprising disposing a plurality of wireless receiver antennae on the apparel worn by the user, the antennae configured to receive power inductively from at least some of the conductors as the user moves about and to provide that power to the VR host.

47. The method of claim 40, wherein the apparel includes one or two shoes.

48. The method of claim 40, wherein the apparel includes a jacket.

49. The method of claim 40, wherein the apparel includes one or two gloves.

50. The method of claim 40, wherein the apparel includes pants or skirts.
